(19) United States
(12) Patent Application Publication
(10) Pub. No.: US 2023/0021751 A1
(43) Pub. Date: Jan. 26, 2023

(54) INTEGRATED CONTROL SYSTEM OF VEHICLE

(71) Applicants: HYUNDAI MOTOR COMPANY, Seoul (KR); KIA CORPORATION, Seoul (KR)

(72) Inventors: Myung Yul Na, Hwaseong-si (KR); Jee Hyuck Choi, Hwaseong-si (KR); Jeong Seon Min, Suwon-si (KR); Yong Ik Kim, Hanam-si (KR); Ki Jung, Hwaseong-si (KR); Ja Yong Koo, Bucheon-si (KR); Yong Hee Kim, Suwon-si (KR); Sun Il Kim, Seongnam-si (KR); Jong Mo Goo, Seoul (KR); Jun Hyeong Lee, Seoul (KR); Bum Woo Nam, Incheon (KR); Bum Jun Kim, Siheung-si (KR)

(73) Assignees: HYUNDAI MOTOR COMPANY, Seoul (KR); KIA CORPORATION, Seoul (KR)

(21) Appl. No.: 17/825,301

(22) Filed: May 26, 2022

(30) Foreign Application Priority Data
Jul. 16, 2021 (KR) 10-2021-0093217

(51) Int. Cl. B60W 50/10; B60W 40/09

(52) U.S. Cl. CPC B60W 50/10; B60W 40/09; B60W 2510/18; B60W 2510/1005; B60W 2510/085

(57) ABSTRACT

An integrated control system of a vehicle includes: a power manager that receives power of a vehicle and supplies power to a first sensor, a second sensor, and a third sensor connected to an accelerator pedal, a brake pedal, and a transmission, respectively; a sensor signal receiver that receives an accelerator pedal output signal, a brake pedal output signal, and a transmission output signal from the first sensor, second sensor, and third sensor, respectively; a main controller that is connected to the power manager, monitors information about power supplied to the first sensor, second sensor, and third sensor, and integrally controls accelerating, braking, and shifting of the vehicle in response to the accelerator pedal output signal, brake pedal output signal, and transmission output signal; and a communicator that sends the accelerator pedal output signal, brake pedal output signal, and transmission output signal to a plurality of relevant control units.

### CROSS REFERENCE TO RELATED APPLICATION

The present application claims the benefit of priority to Korean Patent Application No. 10-2021-0093217, filed on Jul. 16, 2021 in the Korean Intellectual Property Office, the entire contents of which is incorporated herein for all purposes by reference.

### TECHNICAL FIELD

The present disclosure relates to an integrated control system of a vehicle and, more particularly, to an integrated control system of a vehicle which can integrally control accelerating, braking, and shifting signals of a vehicle.

### BACKGROUND

In general, a powertrain independently controls an engine and a transmission in accordance with accelerator pedal input by a driver.

However, as the engine technology has developed and the gear stages of transmission have increased, it has become more complicated to control a powertrain and it has become difficult to optimize the performance of the entire vehicle rather than the performance of each part.

In particular, since shifting is performed by a shift pattern map that depends on an accelerator pedal and a vehicle speed in the existing transmissions, it is required to construct a plurality of maps and shift in accordance with various driving states such as a level road, an uphill road, and a downhill road for smooth driving.

moreover, it is required to suppress the number of revolutions of an engine by shifting into low gears from high gears even when a vehicle speed is low in order to improve fuel efficiency. However, according to this method, it is difficult to cope with surrounding situations such as a change of the slope of a road surface and operation of an accelerator pedal by a driver and direct shifting into lower gears occurs, whereby drivability is deteriorated due to frequent shifting in this situation.

Furthermore, in the related art, control devices such as the accelerator pedal, clutch pedal, and brake pedal perform an input function of transmitting intention of a driver as signals so that a powertrain and a brake system (ESC) can normally operate. However, in the related art, the control devices and relevant controllers are connected through individual hard wires, so wiring is unnecessarily increased, which is unavoidably disadvantageous in terms of manufacturing cost and weight.

Still further, the control devices, which are safety security parts, are parts that are very closely related to the safety of passengers such as engine driving, braking, and shifting; however, claims such as turning-on of a warning light are generated due to unclear reasons. Accordingly, it is required to improve the quality of the parts.

The information disclosed in the Background section above is to aid in the understanding of the background of the present disclosure, and should not be taken as acknowledgement that this information forms any part of prior art.

### SUMMARY

An objective of the present disclosure is to provide an integrated control system of a vehicle which integrally receives an output signal from a sensor for an accelerator pedal, an output signal from a sensor for a brake pedal, and a signal from a sensor for a transmission through sensor signal receivers, determines matching of the output signals from the sensors and whether there is a malfunction, and transmits the output signals to a plurality of corresponding relevant controllers, thereby enabling stable driving of a vehicle and being able to prevent accidents due to a malfunction of the sensors on the basis of the determination on the matching of the output signals.

An integrated control system of a vehicle of the present disclosure includes: a power manager configured to receive power of a vehicle and supply power to a first sensor, a second sensor, and a third sensor connected to an accelerator pedal, a brake pedal, and a transmission, respectively; a sensor signal receiver configured to receive an accelerator pedal output signal, a brake pedal output signal, and a transmission output signal from the first sensor, the second sensor, and the third sensor, respectively; a main controller connected to the power manager, configured to monitor information about power supplied to the first sensor, the second sensor, and the third sensor, and configured to integrally control accelerating, braking, and shifting of the vehicle in response to the accelerator pedal output signal, the brake pedal output signal, and the transmission output signal transmitted from the sensor signal receiver; and a communicator configured to send out the accelerator pedal output signal, the brake pedal output signal, and the transmission output signal to a plurality of relevant control units.

The main controller may include: an accelerator controller configured to compare output values of the accelerator pedal output signal from a first channel and a second channel of the first sensor under a condition in that same power is supplied to the first channel and the second channel, thereby determining matching of the output values; a brake controller configured to determine matching by comparing output values of the brake pedal output signal under a condition in that same power is supplied to a first channel and a second channel of the second sensor; and a shift transmission/reception controller configured to receive and send out a shift range selection signal included in the transmission output signal to the communicator, turn on an LED of a corresponding indicator, and monitor whether the LED is normally turned on.

The accelerator controller may be set such that an output value of the accelerator pedal output signal is sent out at 50% of the first channel of the first sensor through the second channel of the first sensor, and may determine matching by comparing output values of the first channel and the second channel of the first sensor when an output value of the accelerator pedal output signal is input from the first sensor.

When the output value of the accelerator pedal output signal output from the second channel of the first sensor is maintained at 50% of the output value from the first channel of the first sensor, the accelerator controller may convert and send out the output value of the accelerator pedal output signal, which is output from the first sensor, to the communicator.

When the output signal of the accelerator pedal output signal output from the second channel of the first sensor goes out of 50% of the output value output from the first channel of the first sensor by a predetermined error range, the accelerator controller may selectively create a malfunction code for the first sensor.

The communicator may send out the output value of the accelerator pedal output signal to the control unit corresponding to at least one of a VCU

(Vehicle Control Unit) or a CLU (Cluster).

The communicator may send out the fault code to the control unit corresponding to at least one of a VCU (Vehicle Control Unit) or a CLU (Cluster).

The brake controller may be set such that an output value of the brake pedal output signal is sent out at 50% of the first channel of the second sensor through the second channel of the second sensor, and may determine matching by comparing output values of the first channel and the second channel of the second sensor when an output value of the brake pedal output signal is input from the second sensor.

When the output value of the brake pedal output signal output from the second channel of the second sensor is maintained at 50% of the output value from the first channel of the second sensor, the brake controller may convert and send out the output value of the brake pedal output signal, which is output from the second sensor, to the communicator.

When the output signal of the brake pedal output signal output from the second channel of the second sensor goes out of 50% of the output value output from the first channel of the second sensor by a predetermined error range, the brake controller selectively may create and send out a malfunction code for the second sensor to the communicator.

The communicator may send out the output value of the accelerator pedal output signal to the control unit corresponding to at least one of a VCU (Vehicle Control Unit), an IEB (Integrated Electric Booster), an ESC (Electronic Stability Control), or a CLU (Cluster).

The communicator may send out the fault code to the control unit corresponding to at least one of a VCU (Vehicle Control Unit), an IEB (Integrated Electric Booster), an ESC (Electronic Stability Control), or a CLU (Cluster).

The shift transmission/reception controller is connected to a shift range turning-on controller configured to control turning-on of LEDs, turns on an LED in response to a current shift range signal input from the control unit, and selectively generates and sends out a fault code for the third sensor to the communicator when an LED that is controlled to be turned on by the shift range turning-on controller is not normally operated as the result of monitoring the LED.

According to the present disclosure, since the control system is supplied with power of a vehicle and stabilizes the power and then supplies power to the first sensor that transmitting an output signal of an accelerator pedal, the second sensor that transmits an output signal of a brake pedal, and the third sensor that transmits an output signal of an electronic transmitter, there is an effect that it is possible to supply strong power to the sensors by stabilizing power.

Further, since the integrated control system of the present disclosure determines matching of output signals from sensors and whether there is a malfunction, and transmits corresponding signals to a plurality of control units, there is an effect that it is possible to stably drive a vehicle and prevent accidents depending on matching of output signals and a malfunction.

Further, according to the present disclosure, signals related to accelerating, braking, and shifting are transmitted to a plurality of relevant control units by the integrated control system without employing the structure in which an acceleration signal, a braking signal, and a shifting signal are connected to an ECU (Engine Control Unit), an ECU and an IEB (Integrated Electric Booster), and an SCU (Shift Control Unit), respectively in the related art. Accordingly, there is an effect that it is possible to reduce the manufacturing cost by reducing unnecessary wiring in a vehicle and to perform efficient communication with a plurality of relative control units.

### BRIEF DESCRIPTION OF THE DRAWINGS

The above and other objectives, features and other advantages of the present disclosure will be more clearly understood from the following detailed description when taken in conjunction with the accompanying drawings, in which:

FIG. 1 is a diagram showing an integrated control system of a vehicle according to an exemplary embodiment of the present disclosure;

FIG. 2 is a diagram showing an accelerator controller of the integrated control system of a vehicle according to an exemplary embodiment of the present disclosure;

FIG. 3 is a diagram sequentially showing the operation of the accelerator controller of the integrated control system of a vehicle according to an exemplary embodiment of the present disclosure;

FIG. 4 is a diagram showing determining matching of an output value in the operation of the accelerator controller of the integrated control system of a vehicle according to an exemplary embodiment of the present disclosure;

FIG. 5 is a diagram showing a brake controller of the integrated control system of a vehicle according to an exemplary embodiment of the present disclosure; and

FIG. 6 is a diagram sequentially showing the operation of the brake controller of the integrated control system of a vehicle according to an exemplary embodiment of the present disclosure.

### DETAILED DESCRIPTION

Hereinafter, exemplary embodiments of the present disclosure will be described in detail with reference to accompanying drawings.

The advantages and features of the present disclosure, and methods of achieving them will be clear by referring to the embodiments that will be described hereafter in detail with reference to the accompanying drawings.

However, the present disclosure is not limited to the embodiments described hereafter and may be implemented in various ways, the embodiments are provided to complete the description of the present disclosure and let those skilled in the art completely know the scope of the present disclosure, and the present disclosure is defined by claims.

Further, when it is determined that well-known technologies, etc. may make the scope of the present disclosure unclear, they will not be described in detail in the following description.

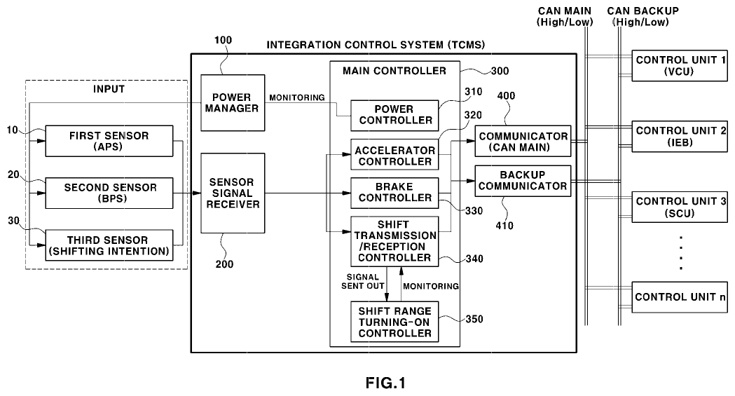

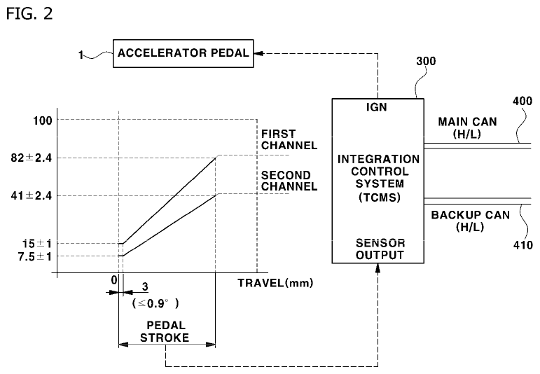

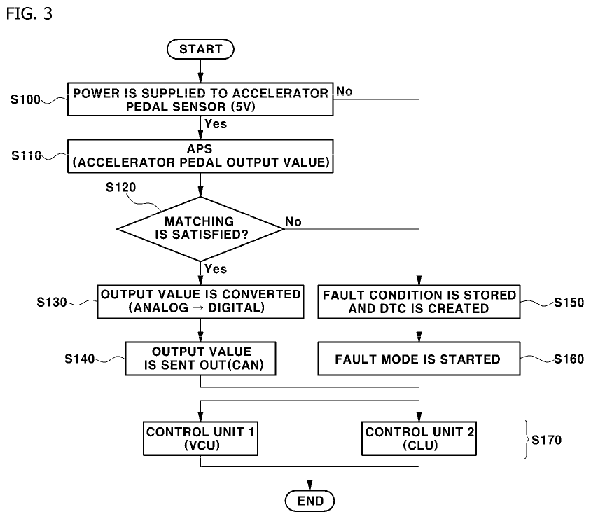

FIG. 1 is a diagram showing an integrated control system of a vehicle according to an exemplary embodiment of the present disclosure, FIG. 2 is a diagram showing an accelerator controller of the integrated control system of a vehicle according to an exemplary embodiment of the present disclosure, and FIG. 3 is a diagram sequentially showing the operation of the accelerator controller of the integrated control system of a vehicle according to an exemplary embodiment of the present disclosure.

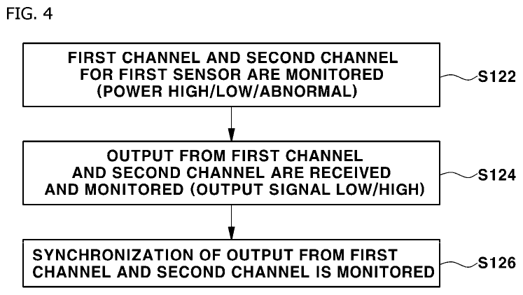

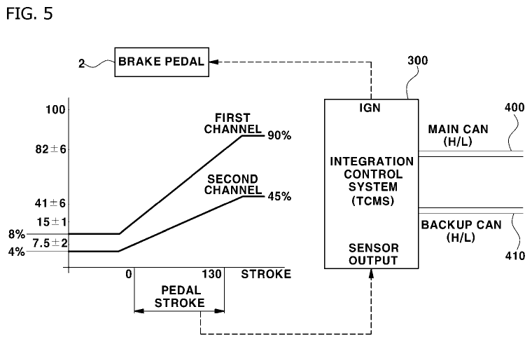

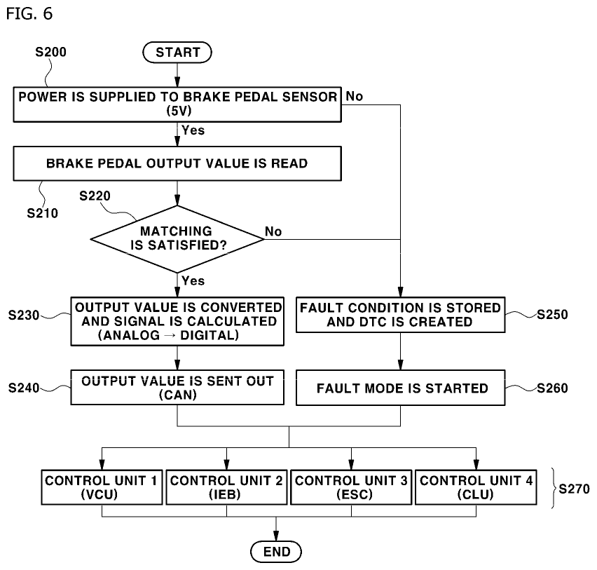

FIG. 4 is a diagram showing determining matching of an output value in the operation of the accelerator controller of the integrated control system of a vehicle according to an exemplary embodiment of the present disclosure, FIG. 5 is a diagram showing a brake controller of the integrated control system of a vehicle according to an exemplary embodiment of the present disclosure, and FIG. 6 is a diagram sequentially showing the operation of the brake controller of the integrated control system of a vehicle according to an exemplary embodiment of the present disclosure.

As shown in FIG. 1, an integrated control system of a vehicle according to the present embodiment includes a power manager 100, a sensor signal receiver 200, a main controller 300, and a communicator 400.

First, the power manager 100 is connected to a vehicle, in detail, a power terminal of an electric vehicle, so it is supplied with power for the vehicle and supplies the power to an accelerator pedal 1, a brake pedal 2, and a first sensor 10, a second sensor 20, and a third sensor 30 connected to a transmission configured in a button, lever, dial, and column type, etc.

The power manager 100 may include a memory and a processor programmed to perform the functions of the power manager 100 described herein.

In detail, the first sensor may be an APS (Accel Position Sensor) and the second sensor 20 may be a BPS (Brake Position Sensor).

The third sensor 30, which is provided to transmit the shifting intention of a driver, may be any one of various types of sensors.

For example, a button type may be configured such that buttons are provided for shift positions (P/R/N/D), respectively, and a contact point is provided for each button, so when a desired shifting range is selected, an electrical signal is generated through the corresponding contact point. Further, lever/dial/column types may be configured such that when they are operated to select a shift range, gears and magnets coupled to the gears are rotated, hall sensors disposed under the gears measure a change of magnetic field due to rotation of the magnets, and an electrical signal corresponding to rotation is generated.

The power manager 100 is connected to be able to integrally supply power for the first sensor 10, the second sensor 20, and the third sensor 30. The power manager 100 can monitor the supply information of the power, which is supplied to the first sensor 10, the second sensor 20, and the third sensor 30, using a power controller 310 of the main controller 300.

In the related art, power managers 100 for supplying power are independently connected the first sensor 10, the second sensor 20, and the third sensor 30, respectively, so wiring is complicated and it is impossible to monitor whether power is correctly supplied to the first sensor 10, the second sensor 20, and the third sensor 30. Accordingly, there may be a problem with stable power supply.

In order to solve this problem, since the poser manager 100 according to the present embodiment is connected to be able to integrally supply power to the first sensor 10, the second sensor 20, and the third sensor 30 and it is possible to monitor power supply information through the power controller 310, it is possible to effectively solve the problem of unstable power supply in the related art. Further, since power is stably supplied, strong power can be supplied to the first sensor 10, the second sensor 20, and the third sensor 30.

The sensor signal receiver 200, which may be a hardware device implemented by various electronic circuits, e.g., processor, to transmit and receive signals via wireless or wired connections, receives an accelerator pedal output signal, a brake pedal output signal, and a transmission output signal from the first sensor 10, the second sensor 20, and the third sensor 30, respectively.

The sensor signal receiver 200 receives output values corresponding to PWM(Pulse Width Modulation) duty sent out as two values through a first channel and a second channel from the first sensor 10 and the second sensor 20, respectively, and transmits the output values to the main controller 300, which will be described below, for matching determination.

The sensor signal receiver 200 can receive an electrical signal corresponding to shifting intention of a driver for any one of a button type or a lever/dial/column type from the third sensor 30, as described above.

The main controller 300 is connected to the power manager 100 through the power controller 310 and can monitor the supply information of the power that is supplied to the first sensor 10, the second sensor 20, and the third sensor 30.

The main controller 300 integrally controls accelerating, braking, and shifting of a vehicle in response to the accelerator pedal output signal, the brake pedal output signal, and the transmission output signal transmitted from the sensor signal receiver 200.

To this end, the main controller 300 includes an accelerator controller 320, a brake controller 330, and a shift transmission/reception controller 340.

Each of the controllers 310, 320, 330 and 340 of the main controller 300 according to an exemplary embodiment of the present disclosure may be a processor (e.g., computer, microprocessor, CPU, ASIC, circuitry, logic circuits, etc.). Each controller may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor may be implemented as a single integrated semiconductor circuit. The processor may embody one or more processor(s). According to another exemplary embodiment of the present disclosure, a single integrated processor may perform the functions of all of the controllers 310, 320, 330 and 340, and the controllers 310, 320, 330 and 340 may be implemented with software instructions executed on the single processor.

The accelerator controller 320 of the main controller 300 can receive an output value from the first sensor 10, in detail, a stroke sensor of an accelerator pedal, as shown in FIG. 2, and can send out the output value to a relevant control unit, for example, a VCU (Vehicle Control Unit) so that the accelerator pedal 1 is operated to correspond to the output value.

When sending out the output value, the accelerator controller 320 determines first matching by comparing output values of the accelerator pedal output signal under the condition that the same power is supplied to the first channel and the second channel of the first sensor 10, and then converts and transmits the output value to the communicator 400 after matching is determined.

The communicator 400 may be a hardware device (e.g., a transceiver, etc.) implemented by various electronic circuits, e.g., processor, to transmit and receive signals via wireless or wired connections.

To this end, the accelerator controller 320 receives output values corresponding to PWM duty sent out as two values from the first channel and the second channel of the first sensor 10 through the sensor signal receiver 200, and compares the output values to determine correction.

Operation of the accelerator controller 320 including the process of determining matching is sequentially described hereafter with reference to FIG. 3.

First, for example, 5V power is supplied to the first sensor 10 through the power manager 100 (S100).

If it is determined that 5V power is not supplied as the result of monitoring the power manager 100 through the power controller 310, the main controller 300 stores the fault condition, creates a DTC (Diagnostic Trouble Code) (S150), and starts a fault mode (S160).

When the accelerator pedal 1 is operated with power supplied as described above (S100), output values are output from an APS (Accel Position Sensor), that is, the first sensor 10 (S110).

In this case, matching of the output values is determined (S120).

In other words, as shown in FIG. 4, power is supplied to the first channel and the second channel of the first sensor 10 and whether power has been normally supplied to the first channel and the second channel is determined by monitoring the power manager 100 through the power controller 310 (S122).

Assuming that the same power is supplied to the first channel and the second channel, the second channel has been set to send out an output value at a predetermined level, in detail, output an output value with PWM duty that is 50% of the PWM duty of the first channel for a stroke of the accelerator pedal 1. Accordingly, the accelerator controller 320 compares the output values from the first channel and the second channel for a stroke of the accelerator pedal 1, that is, compares the PWM duty value from the second channel with the PWM duty from the first channel to determine matching of the output values from the first sensor (S124).

If the PWM duty value from the second channel is maintained at 50% of the PWM duty from the first channel, it is determined that the output values from the first sensor 10 are normal (S126), that is, matching determination is finished, and output values of analog signal are converted into output values of digital signal (S130).

The output values converted into a digital signal are transmitted to the communicator 400 using CAN, etc. (S140), and the communicator 400 sends out the output values to control units related to the output values (S170).

The communicator 400 sends out the output values of accelerator pedal output signal of which matching has been determined to a control unit corresponding to a control unit corresponding to at least one of a VCU (Vehicle Control Unit) or a CLU(Cluster).

The type of the control unit is limited to at least one or more of a VCU (Vehicle Control Unit) and a CLU(Cluster), but the output value of an accelerator pedal output signal may be sent out to other control units that can perform different types of control, depending on the output value.

When the output value from the second channel goes out of 50% of the output value from the first channel by a predetermined error range, in detail, the PWM duty value from the second channel goes out of 50% of the PWM duty value of the first channel by a predetermined error range, for example, by 2% of the PWM duty value of the first channel as the result of comparing output values transmitted from the first channel and the second channel for a stroke of the accelerator pedal 1 through the sensor signal receiver 200, that is, as the result of determining matching, the accelerator controller 320 stores the fault condition, creates a DTC (Diagnostic Trouble Code) (S150), and starts a fault mode (S160).

Accordingly, when the fault condition is stored in the main controller 300 and the fault mode is started, the accelerator controller 320 transmits the fault condition stored in the main controller 300 together with the DTC to the driver using the communicator 400 and the backup communicator 420, whereby when the accelerator pedal 1 has a fault, an accident due to the fault can be prevented.

The backup communicator 410 performs the same function as the communicator 400 and may be provided to replace the communicator 400 when the communicator 400 has a fault due to a short circuit, etc.

The communicator 400 also sends out information according to entry into the fault mode (including the created DTC) to a control unit corresponding to at least one of a VCU (Vehicle Control Unit) or a CLU (Cluster).

Meanwhile, the brake controller 330 of the main controller 300 can receive an output value from the second sensor 20, in detail, a stroke sensor of a brake pedal 1 mounted on an electric vehicle, as shown in FIG. 5, and can send out the output value to a relevant control unit, for example, an IEB (Integrated Electric Booster) so that the brake pedal 2 is operated to correspond to the output value.

The brake controller 330 receives output values corresponding to output values, that is, PWM duty values sent out as two values from the first channel and the second channel of the second sensor 20 through the sensor signal receiver 200, and compares the PWM duty values to determine matching.

Operation of the brake controller 330 including the process of determining correction is sequentially described hereafter with reference to FIG. 5.

First, for example, 5V power is supplied to the second sensor 20 through the power manager 100 (S100).

If it is determined that 5V power is not supplied as the result of monitoring the power manager 100 through the power controller 310, the main controller 300 stores the fault condition, creates a DTC (Diagnostic Trouble Code) (S250), and starts a fault mode (S260).

When the brake pedal 2 is operated with power supplied as described above (S100), output values are output from a BPS (Brake Position Sensor), that is, the second sensor 20 (S210).

In this case, matching of the output values are determined (S220).

The process of determining matching of the output values from the second sensor 20 is the same as the process of determining matching of the output values from the first sensor 10 (see FIG. 4), so the process is not described in detail in the present embodiment.

When matching of the output values from the second sensor 20 is determined, the output values of analog signal are converted into output values of digital signal (S230).

As described above, the output values converted into a digital signal are transmitted to the communicator 400 using CAN, etc. (S240), and the communicator 400 sends out the output values to a plurality of control units related to the output values (S270).

The communicator 400 sends out the output values of accelerator pedal output signal of which matching has been determined to a control unit corresponding to a control unit corresponding to at least one of a VCU (Vehicle Control Unit), an IEB (Integrated Electric Booster), an ESC (Electronic Stability Control), or a CLU (Cluster).

The type of the control unit is limited to at least one of a VCU (Vehicle Control Unit), an IEB (Integrated Electric Booster), an ESC (Electronic Stability Control), or a CLU (Cluster), but the output value of a brake pedal output signal may be sent out to other control units that can perform different types of control, depending on the output value.

When the PWM duty value from the second channel goes out of 50% of the PWM duty value from the first channel by a predetermined error range (when the PWM duty value from the second channel goes out of 50% of the PWM duty value from the first channel by 2% of the PWM duty value from the first channel, for example, when the PWM duty value from the first channel is 90% and the PWM duty value from the second channel exceeds 46.8% or is less than 43.2%) as the result of comparing output values transmitted from the first channel and the second channel for a stroke of the brake pedal 2 through the sensor signal receiver 200, that is, as the result of determining matching, the brake controller 330 stores the fault condition, creates a DTC (Diagnostic Trouble Code) (S250), and starts the fault mode (S260).

Accordingly, when the fault condition is stored in the main controller 300 and the fault mode is started, the brake controller 330 transmits the fault condition stored in the main controller 300 together with the DTC to the driver using the communicator 400 and the backup communicator 420, whereby when the brake pedal 2 has a fault, an accident due to the fault can be prevented.

The backup communicator 410 performs the same function as the communicator 400 and may be provided to replace the communicator 400 when the communicator 400 has a fault due to a short circuit, etc.

The communicator 400 also sends out information according to entry into the fault mode (including the created DTC) to a control unit corresponding to at least any one of a VCU (Vehicle Control Unit), an IEB (Integrated Electric Booster), an ESC (Electronic Stability Control), and a CLU (Cluster).

Meanwhile, the shift transmission/reception controller 340 of the main controller 300 receives a shift range selection signal included in a transmission output signal from the third sensor 30, sends out the shift range selection signal to the communicator 400, turns on the LED of a corresponding indicator, and monitors whether the LED is normally turned on.

That is, the shift transmission/reception controller 340 receives an electrical signal corresponding to the shift range selection signal according to shifting intention of a driver from the sensor signal receiver 200, converts the electrical signal into a digital signal, and sends out the digital signal to a corresponding control unit, in detail, to an SCU (Shift Control Unit) through the communicator 400 so that shifting is controlled.

The shift transmission/reception controller 340 is connected to a shift range turning-on controller 350 that turns on an LED, receives the current shift range signal from a control unit such as an SCU (Shift Control Unit), and turns on the LED of the indicator for showing the current shift range.

When the LED is not normally operated, for example, the LED is not turned on or the currently shown shift range does not coincide with a corresponding shift range and the LED of another shift range indicator is turned on, the shift range turning-on controller 350 creates and sends out a fault code for the third sensor 30 to the communicator 400.

Accordingly, since the fault code is created and corresponding signals are sent out through the communicator 400, a driver can intuitionally monitor whether the LEDs are normally turned on.

According to the present disclosure, since the integrated control system is supplied with power of a vehicle and stabilizes the power and then supplies power to the first sensor that transmitting an output signal of an accelerator pedal, the second sensor that transmits an output signal of a brake pedal, and the third sensor that transmits an output signal of an electronic transmitter, there is an effect that it is possible to supply strong power to the sensors by stabilizing power.

Further, since the integrated control system of the present disclosure determines matching of output signals from sensors and whether there is a malfunction, and transmits corresponding signals to a plurality of control units, there is an effect that it is possible to stably drive a vehicle and prevent accidents depending on matching of output signals and a malfunction.

Further, according to the present disclosure, signals related to accelerating, braking, and shifting are transmitted to a plurality of relevant control units by the integrated control system without employing the structure in which an acceleration signal, a braking signal, and a shifting signal are connected to an ECU (Engine Control Unit), an ECU and an IEB(Integrated Electric Booster), and an SCU(Shift Control Unit), respectively in the related art. Accordingly, there is an effect that it is possible to reduce the manufacturing cost by reducing unnecessary wiring in a vehicle and to perform efficient communication with a plurality of relative control units.

Although the present disclosure was described with reference to the embodiment(s) shown in the drawings, but this is only an example and it would be understood by those skilled in the art that the present disclosure may be changed in various ways and may be achieved by selectively combining all or some of the embodiment(s). Therefore, the technical protective region of the present disclosure should be determined by the scope described in claims.

What is claimed is:

1. An integrated control system of a vehicle, comprising:
a power manager configured to receive power of a vehicle and supply power to a first sensor, a second sensor, and a third sensor connected to an accelerator pedal, a brake pedal, and a transmission, respectively;
a sensor signal receiver configured to receive an accelerator pedal output signal, a brake pedal output signal, and a transmission output signal from the first sensor, the second sensor, and the third sensor, respectively;
a main controller connected to the power manager, configured to monitor information about the power supplied to the first sensor, the second sensor, and the third sensor, and configured to integrally control accelerating, braking, and shifting of the vehicle in response to the accelerator pedal output signal, the brake pedal output signal, and the transmission output signal transmitted from the sensor signal receiver; and
a communicator configured to send out the accelerator pedal output signal, the brake pedal output signal, and the transmission output signal to a plurality of relevant control units.

2. The integrated control system of claim 1, wherein the main controller includes:
an accelerator controller configured to compare output values of the accelerator pedal output signal from a first channel and a second channel of the first sensor under a condition in that same power is supplied to the first channel and the second channel, thereby determining matching of the output values;
a brake controller configured to determine matching by comparing output values of the brake pedal output signal under a condition in that same power is supplied to a first channel and a second channel of the second sensor; and
a shift transmission/reception controller configured to receive and send out a shift range selection signal included in the transmission output signal to the communicator, turn on an LED of a corresponding indicator, and monitor whether the LED is normally turned on.

3. The integrated control system of claim 2, wherein the accelerator controller is set such that an output value of the accelerator pedal output signal is sent out at 50% of the first channel of the first sensor through the second channel of the first sensor, and determines matching by comparing output values of the first channel and the second channel of the first sensor when an output value of the accelerator pedal output signal is input from the first sensor.

4. The integrated control system of claim 3, wherein when the output value of the accelerator pedal output signal output from the second channel of the first sensor is maintained at 50% of the output value from the first channel of the first sensor, the accelerator controller converts and sends out the output value of the accelerator pedal output signal, which is output from the first sensor, to the communicator.

5. The integrated control system of claim 3, wherein when the output signal of the accelerator pedal output signal output from the second channel of the first sensor goes out of 50% of the output value output from the first channel of the first sensor by a predetermined error range, the accelerator controller selectively creates a fault code for the first sensor.

6. The integrated control system of claim 4, wherein the communicator sends out the output value of the accelerator pedal output signal to the control unit corresponding to at least one of a VCU (Vehicle Control Unit) or a CLU (Cluster).

7. The integrated control system of claim 5, wherein the communicator sends out the fault code to the control unit corresponding to at least one of a VCU (Vehicle Control Unit) or a CLU (Cluster).

8. The integrated control system of claim 2, wherein the brake controller is set such that an output value of the brake pedal output signal is sent out at 50% of the first channel of the second sensor through the second channel of the second sensor and determines matching by comparing output values of the first channel and the second channel of the second sensor when an output value of the brake pedal output signal is input from the second sensor.

9. The integrated control system of claim 8, wherein when the output value of the brake pedal output signal output from the second channel of the second sensor is maintained at 50% of the output value from the first channel of the second sensor the brake controller converts and sends out the output value of the brake pedal output signal, which is output from the second sensor, to the communicator.

10. The integrated control system of claim 8, wherein when the output signal of the brake pedal output signal output from the second channel of the second sensor goes out of 50% of the output value output from the first channel of the second sensor by a predetermined error range, the brake controller selectively creates and sends out a malfunction code for the second sensor to the communicator.

11. The integrated control system of claim 9, wherein the communicator sends out the output value of the accelerator pedal output signal to the control unit corresponding to at least one of a VCU (Vehicle Control Unit), an IEB (Integrated Electric Booster), an ESC (Electronic Stability Control), or a CLU (Cluster).

12. The integrated control system of claim 10, wherein the communicator sends out the fault code to the control unit corresponding to at least one of a VCU (Vehicle Control Unit), an IEB (Integrated Electric Booster), an ESC (Electronic Stability Control), or a CLU (Cluster).

13. The integrated control system of claim 2, wherein the shift transmission/reception controller is connected to a shift range turning-on controller configured to control turning-on of LEDs, turns on an LED in response to a current shift range signal input from the control unit, and selectively generates and sends out a fault code for the third sensor to the communicator when an LED that is controlled to be turned on by the shift range turning-on controller is not normally operated as the result of monitoring the LED.
